(19) United States
(12) Patent Application Publication
(10) Pub. No.: US 2009/0303076 A1
(43) Pub. Date: Dec. 10, 2009

(54) WIRELESS AND BATTERY-LESS MONITORING UNIT

(75) Inventors: Dadi Setiadi, Edina, MN (US); Song S. Xue, Edina, MN (US); Insik Jin, Eagan, MN (US)

Correspondence Address: CAMPBELL NELSON WHIPPS, LLC, HISTORIC HAMM BUILDING, 408 SAINT PETER STREET, SUITE 240, ST. PAUL, MN, 55102, US

(73) Assignee: SEAGATE TECHNOLOGY LLC, Scotts Valley, CA (US)

(21) Appl. No.: 12/132,673

(22) Filed: Jun. 4, 2008

(51) Int. Cl. G08C 19/16

(52) U.S. Cl. 340/870.01

(57) ABSTRACT

A wireless and battery-less sensor device is described. The sensor device includes a mechanical energy harvesting device, a sensor electrically coupled to the mechanical energy harvesting module. The sensor is configured to sense with the power supplied by the mechanical energy harvesting device. Nonvolatile memory is configured to store output from the sensor. A radio frequency energy harvesting module is electrically coupled to a radio frequency transmitter. The radio frequency transmitter is configured to transmit the output from the sensor with the power supplied by the radio frequency energy harvesting device. Systems and methods utilizing the wireless and battery-less sensor device are also described.

### BACKGROUND

Monitoring sensors are usually installed on one or several locations which measure specific parameter of interest imposed on each location. However, the wiring management of these sensor systems can be a challenging problem. While it is difficult to assess cost associated with management of these wires, it is evident that wire management is a major source for labor intensity and the long installation time.

Various types of platforms such as, for example, fixed structures, buildings, and vehicles, are subjected to various environmental conditions such as stress and strain, exposure to temperature extremes, and/or vibration energy. Due to the various environmental conditions such components can suffer material degradation over time. Monitoring these bodies for structural health is often desired.

Structural health monitoring helps promote realization of the full potential of bodies or structural components. Remotely positioned sensors have been installed adjacent to such structural components to monitor various parameters such as, for example, strain levels, stress, temperature, pressure, or vibration level to help manage physical inspection schedules, maintenance schedules, to help predict material failure, and generally monitor the “health” of such components. Such sensors have been provided a dedicated power supply such as power obtained through conductors, e.g., wires, or through chemical batteries. Depending upon available space, batteries can be inappropriate due to their size. Batteries can also have a limited service life and, therefore, typically require periodic inspection and/or replacement, are often positioned in locations difficult to reach, and often require costly disassembly and reassembly of the sensor or component to perform service on the battery. Further, batteries may not be suitable due to environmental constraints, i.e., temperature changes often affect battery performance.

To eliminate the issue of wire management and to reduce the cost of sensor installation, sensors systems with innovative wireless technology are sought. Additionally, to minimize the maintenance burden of battery power, self-powered sensors with energy harvesting techniques are desired. Since structural defects can occur at any time during service, continuous monitoring of potential damage initiation and growth by autonomous self-powered and wireless sensor systems can not only save a great deal of maintenance costs but also improve safety.

In view of the foregoing, it would be desirable to provide a self-powered sensor system that reduces dependence on batteries or any other external power source.

### BRIEF SUMMARY

The present disclosure relates to a sensor-monitoring device that includes a self-powered sensor and a radio frequency transmitter. The sensor utilizes a vibration energy harvesting module to power the sensor. A radio frequency energy harvester powers the radio frequency transmitter for backscatter modulation data communication. The relatively small size and wireless nature of this system allows it to be quickly attached to a surface of interest where it collects, processes, and stores data.

In one exemplary embodiment, a wireless and battery-less sensor device includes a mechanical energy harvesting device, a sensor electrically coupled to the mechanical energy harvesting module. The sensor is configured to sense with the power supplied by the mechanical energy harvesting device. Nonvolatile memory is configured to store output from the sensor. A radio frequency energy harvesting module is electrically coupled to a radio frequency transmitter. The radio frequency transmitter is configured to transmit the output from the sensor to a remote radio frequency interrogation device with the power supplied by the radio frequency energy harvesting device.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic diagram of an illustrative wireless and battery-less system to monitor a body;

FIG. 2 is a schematic block diagram of an illustrative wireless and battery-less device;

FIG. 3 is a schematic block diagram of an illustrative radio frequency interrogator for the device shown in FIG. 2.

FIG. 4 is a flow chart for operation of an exemplary wireless and battery-less device; and

FIG. 5 is a flow diagram for operation of an exemplary wireless and battery-less device.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying set of drawings that form a part hereof and in which are shown by way of illustration several specific embodiments. It is to be understood that other embodiments are contemplated and may be made without departing from the scope or spirit of the present disclosure. The following detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

Monitoring sensors are usually installed on one or several locations which measure specific parameter of interest imposed on each location. However, the wiring management of the sensor systems can be a challenging problem. While it is difficult to assess cost associated with management of these wires, it is evident that wire management is a source for labor intensity and the long installation time. Therefore, to eliminate the issue of wire management and to reduce the cost of sensor installation, sensors systems with innovative wireless technology are sought. Additionally, to minimize the maintenance burden of battery power, self-powered sensors with energy harvesting techniques are desired. Since structural defects can occur at any time during service, continuous monitoring of potential damage initiation and growth by autonomous self-powered and wireless sensor systems can not only save a great deal of maintenance costs but also improve safety.

Radio frequency identification (RFID) systems provide wireless connection from the sensors to an onboard base station for data collection. In general, the RFID systems are divided into two broad categories: active and passive RFIDs. The active RFID has long reading ranges (up to several hundred meters) but is expensive and requires batteries and maintenance. While compared to the active RFID, the passive RFID has a relatively lower cost and requires no battery and maintenance, allowing more widespread use. The passive RFID is often powered from the energy transmitted by the reader and makes use of the backscatter principal to return data to the reader.

The present disclosure relates to a sensor-monitoring device (i.e., wireless and battery-less device) that includes a self-powered sensor and a RF transmitter. The sensor utilizes a vibration energy harvesting module to power the sensor. A radio frequency energy harvester powers the radio frequency transmitter for backscatter modulation data communication. The relatively small size and wireless nature of this system allows it to be quickly attached to a surface of interest where it collects, processes, and stores data. The wireless and battery-less device can be in the form of small disposable radio frequency ID (RFID) thin film patch with a self powered sensor. The wireless and battery-less device has a unique identification system and the capability to measure sensory parameter of the component of interest and transmit the measured data wirelessly. This wireless and battery-less sensor eliminates wiring management and minimizes the maintenance burden of battery power. This system can employ data-logging transceivers, which represent much greater flexibility in terms of how sensors are powered and how the sensed data is locally managed. It is designed to enable a large number of sensors deployed throughout the components of interest to communicate with a central (and remote) server or computer.

The wireless and battery-less device described herein uses a self-powered sensor (via a mechanical energy harvesting module), and a backscatter modulation technique data communication. In many embodiments, the wireless and battery-less device is composed of an antenna, a self-powered sensor, and a RFID. In many embodiments, the self-powered sensor includes a sensor, low power signal conditioning circuits for the sensor, a mechanical energy harvesting module to power the sensor, and a power generator circuit. In many embodiments, the RFID transmitter includes of a micro-controller, nonvolatile memory, instruction sequencer, detection circuit, and basic modulation circuitry. The wireless and battery-less device is powered by two energy sources: mechanical vibration of the environment where the device can attach to, and electrical/magnetic field created by the reader/interrogator, respectively. The mechanical vibration will power the sensor, and save the measured data into the nonvolatile memory. Expected generated energy from the mechanical vibration will be in the order of hundreds of microwatt. Hence, it is not enough to power the entire wireless and battery-less device. The RF field generated by the reader is used to create an electrical energy to power the RFID transmitter. Expected generated energy is about one milliwatt. In addition, this RF field is also used to send the data back from the wireless and battery-less device to the reader using the backscatter principal. The wireless and battery-less device will send data as requested by the reader/interrogator. While the present disclosure is not so limited, an appreciation of various aspects of the disclosure will be gained through a discussion of the examples provided below.

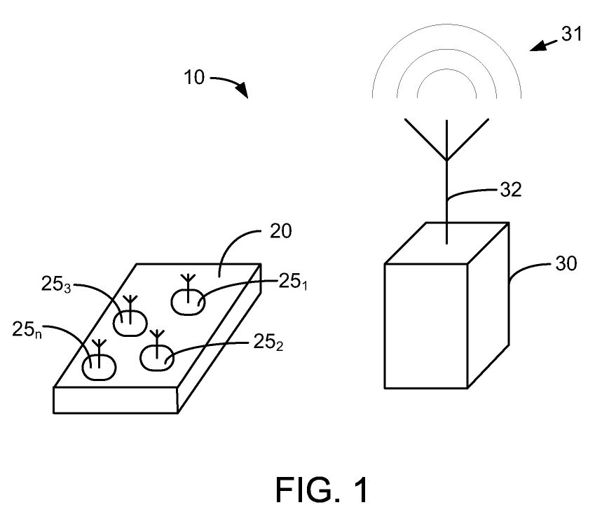

FIG. 1 is a schematic diagram of an illustrative wireless and battery-less system 10 to monitor a body 20. The system 10 includes a body 20 to be monitored, a remote radio frequency interrogation device 30, and at least one wireless and battery-less sensor device 25ₙ disposed to monitor the body 20 and transmit sensed output to the remote radio frequency interrogation device 30.

The body 20 can be anything to be monitored. In many embodiments the body 20 is capable of providing sufficient vibration energy to power the wireless and battery-less sensor device 25ₙ. In some embodiments the body 20 is a portion of a fixed structure or a civil structure such as, for example, a building, bridge, road, and the like. In some embodiments the body 20 is a portion of a moving structure such as, for example, a vehicle, plane, human body, and the like. While four wireless and battery-less sensor devices 25₁, 25₂, 25₃, 25ₙ are illustrated, any number of sensor devices can be arranged and monitored, as desired. These wireless and battery-less sensor devices 25ₙ can be disposed on or in the body 20. In some embodiments, these wireless and battery-less sensor devices 25ₙ can be disposed on a body 20 to assist in assessing the structural health (e.g., vibration, deflection, stress, strain, temperature, pressure) of the body 20.

The sensor device 25ₙ includes a mechanical energy harvesting module that provides electrical power to a sensor. The sensor provides an output that is stored in nonvolatile memory. A radio frequency energy harvesting module provides electrical power to a radio frequency transmitter in the sensor device for transmission of the output stored in the nonvolatile memory to the remote radio frequency interrogation device. The sensor device 25ₙ is described in further detail below.

The remote radio frequency interrogation device 30 is physically separated from the body 20 and the sensor device 25ₙ. In many embodiments, the remote radio frequency interrogation device 30 is physically separated from the body 20 and the sensor device 25ₙ a distance of at least 1 centimeter, or at least 1 meter, or at least 10 meters. The remote radio frequency interrogation device 30 includes an antenna 32 that emits radio frequency energy 31 that powers the radio frequency transmitter in the sensor device 25ₙ for transmission of the output stored in the nonvolatile memory to the remote radio frequency interrogation device 30.

In many embodiments, the system 10 utilizes a passive communication scheme. According to such passive scheme, a request for data by the remote radio frequency interrogation device 30 can take the form of providing an RF signal 31 having a preselected frequency and/or obtaining a certain level of energy from the signal. In response to such a request, the sensor device 25ₙ can enable communication by tuning the receiving antenna and/or the load across a receiving antenna using an inductive or backscattering coupling scheme. The remote radio frequency interrogation device 30 senses the change in load or resonant frequency to receive data from each sensor device 25ₙ.

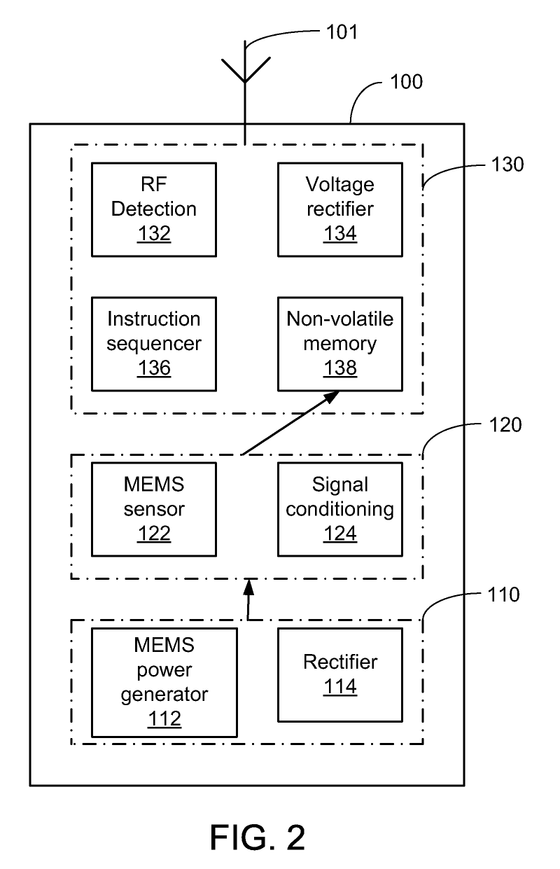

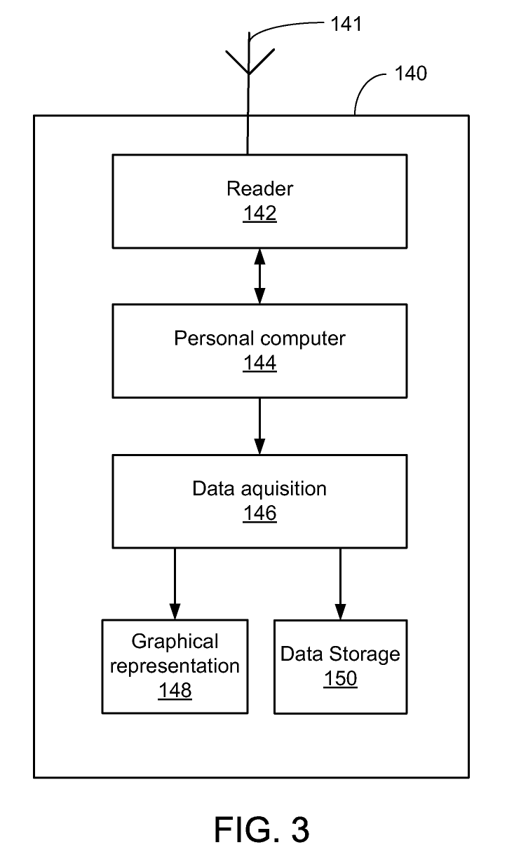

FIG. 2 is a schematic block diagram of an illustrative wireless and battery-less device. FIG. 3 is a schematic block diagram of an illustrative radio frequency interrogator for the device shown in FIG. 2. The wireless and battery-less device 100 includes a mechanical energy harvesting module 110 that provides electrical power to a sensor 120. The sensor 120 provides an output that is stored in nonvolatile memory 138. A radio frequency energy harvesting module 130 provides electrical power to a radio frequency transmitter 101 in the wireless and battery-less device 100 for transmission of the output stored in the nonvolatile memory 138 to the remote radio frequency interrogation device 140 (FIG. 3).

The wireless and battery-less device 100 includes an antenna 101, a self-powered sensor 110, 120, and a RFID transmitter 130. The self-powered sensor 110, 120 includes a sensor 122, low power signal conditioning circuits or a signal conditioning module 124 for the sensor or MEMS sensor 122, an energy harvesting device or MEMS power generator 112, and a power generator circuit or rectifier module 114. The RFID transmitter 130 includes a micro-controller, nonvolatile memory 138, instruction sequencer 136, detection circuit or RF detection module 132, and basic modulation circuitry or a voltage rectifier module 134.

The sensor or MEMS sensor 122 can be configured to monitor or measure any useful parameter of interest. For example, the sensor or MEMS sensor 122 can be in the form of a strain gage, temperature sensor, pressure sensor, accelerometers, acoustic receiver, or other form of sensor known to those skilled in the art. If more than one sensor or MEMS sensor 122 is installed to monitor a body, each sensor or MEMS sensor 122 can be configured to monitor the same or different parameter of interest. For example, in order to provide temperature compensated strain, one sensor or MEMS sensor 122 can be a piezoelectric strain gage, while another sensor or MEMS sensor 122 can be a temperature sensor. The sensor or MEMS sensor 122 can be operated with low power requirements such as, for example, less than 1 milliwatt, or 500 microwatts or less, or 300 microwatts or less, or 200 microwatts or less. The sensor or MEMS sensor 122 output can be an analog or digital signal.

The wireless and battery-less device 100 is powered by two energy sources: a mechanical vibration of the components where the patches attach to, and electrical/magnetic field created by the reader/interrogator, respectively. The mechanical vibration will power (via the mechanical energy harvester 110) the sensor 120, and save the measured data into the embedded memory 138. Expected generated energy from the mechanical vibration will be in the order of hundreds of microwatt such as for example, less than 1 milliwatt, or 500 microwatts or less, or 300 microwatts or less, or 200 microwatts or less. Hence, it is not enough to power the entire wireless and battery-less device 100. The RF field 31 (FIG. 1) generated by the reader/interrogator 140 is used to create an electrical energy to power the RFID transmitter 130. Expected generated energy from the RF field is about one milliwatt, or at least one milliwatt, or at least 2 milliwatts. In addition, this RF field is also used to send the data back from the wireless and battery-less device 100 to the reader 140 using the backscatter principal, for example. In many embodiments, the system is a passive system and will only send data as requested by the reader 140.

The mechanical energy harvester 110 can be any useful device that is capable of converting mechanical vibration into electrical power at the levels described above. In many embodiments, the mechanical energy harvester 110 is an inertial device that translates movement of an inertial mass into electrical power. Exemplary conversion mechanisms include piezoelectric, electrostatic and electromagnetic. Piezoelectric conversion refers to using piezoelectric material to convert strain in a spring into electricity. Electrostatic conversion refers to an arrangement with a permanent charge embedded in the mass which induces a voltage on plates of a capacitor as it moves. Electromagnetic refers to a magnet attached to the mass which induces a voltage in a coil as it moves. The mechanical energy harvester 110 can be a MEMS device. These vibration-driven micropower generators can also be described or classified as coulomb-damped resonant generators, velocity-damped resonant generators, or coulomb-force parametric generators.

In exemplary embodiments, the remote radio frequency interrogation device 140 includes a reader 142, personal computer 144, data acquisition module 146, graphical representation 148, and data storage 150. The reader 142 includes a micro controller, a detection circuit, an instruction sequencer, an antenna 141, and a reader circuit, which transmits energy to the wireless and battery-less device 100, transmits command to the wireless and battery-less device 100, and detects backscatter data modulation. In many embodiments, the reader 142 receives data in the form of a serial bit pattern modulating the reflected wave from the wireless and battery-less device 100. The reader 142 interfaces to the PC 144 with the assessment data acquisition 146 program through a PCI bus, for example.

Communication between the reader 142 and wireless and battery-less device 100 can take place with electromagnetic coupling between the antennas 101, 141 of the wireless and battery-less device 100 and the reader 142. The RFID transmitter 130 is energized by a time varying electromagnetic radio frequency (RF) wave that is transmitted from the reader 142. This RF signal is called a carrier signal. When the RF field passes through an antenna 101, there is an AC voltage generated across the antenna 101. The voltage is rectified 134 to power the RFID transmitter 130, and to send the data to the reader 142. In many embodiments, the RFID transmitter 130 becomes functional as soon as the power supply voltage (VDD) on the RFID transmitter 130 reaches a specified operating voltage level. In response to commands received from the reader 142, the RFID transmitter 130 stored data is transmitted to the reader 142. The reader 142 reads values of the memory based on first in first out protocol, for example.

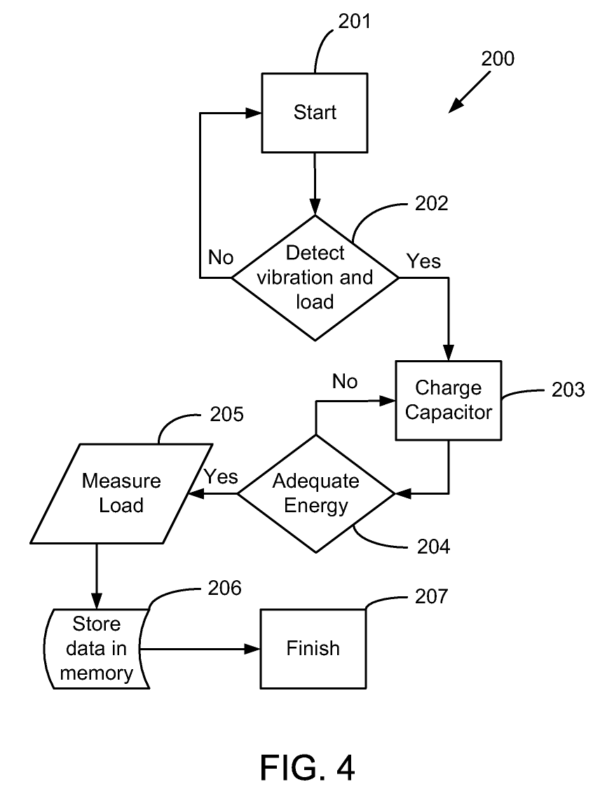

FIG. 4 is a flow chart 200 for operation of an exemplary wireless and battery-less device. The operation starts at block 201. When vibration is detected at block 202, a mechanical energy harvesting device converts the mechanical vibration into electric voltage by charging the capacitor at block 203. As long as the energy level threshold is not reached, all other circuits are in sleep mode. At block 204, if the threshold is reached, the sensor measures and converts the measured data into a digital signal at block 205 and store the data in memory at block 206, and the operation finishes at block 207. The generated power by the energy harvesting device is used to measure the sensory parameter on the wireless and battery-less device. It is not used to send the data to the reader. Therefore, a much smaller power generator is required, and it keeps the size of the wireless and battery-less device. It is part of a power management strategy in which the wireless and battery-less device is powered by two sources: mechanical vibration and radio frequency electrical field, respectively.

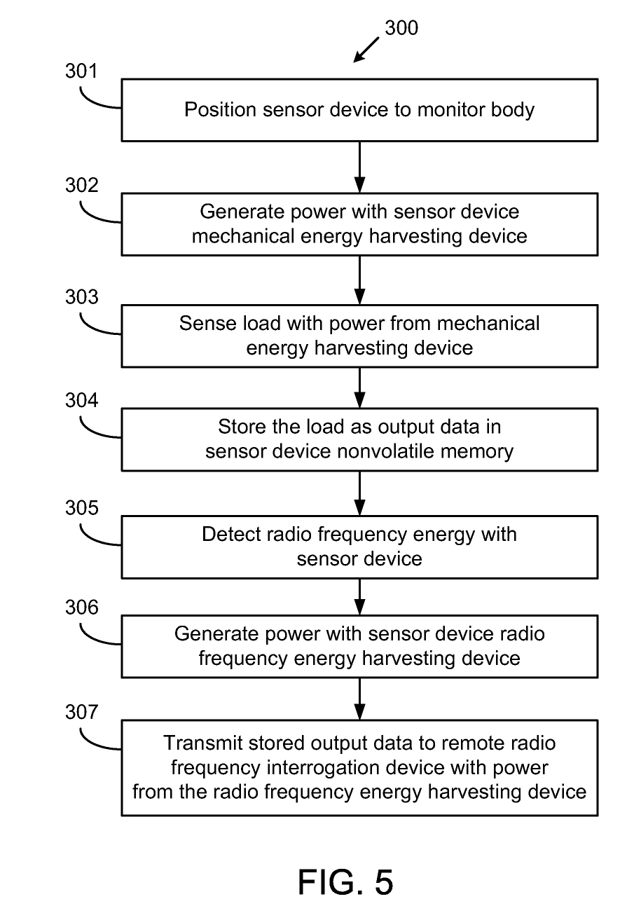

FIG. 5 is a flow diagram 300 for operation of an exemplary wireless and battery-less device. The method 300 includes positioning at least one wireless and battery-less sensor device to monitor a body at block 301. In many embodiments, the wireless and battery-less sensor device includes a mechanical energy harvesting module, a sensor, nonvolatile memory, a radio frequency energy harvesting module, and a radio frequency transmitter. At block 302, the method includes generating electrical power with the mechanical energy harvesting module. At block 303 the method includes sensing a load on the sensor with power supplied by the mechanical energy harvesting module. This sensed load is then stored as output data in the nonvolatile memory at block 304. The RF transmitter is powered by detecting radio frequency energy with the wireless and battery-less sensor device at block 305, and generating electrical power with the radio frequency energy from the radio frequency energy harvesting module at block 306. The stored output data is then transmitted from the nonvolatile memory to a remote radio frequency interrogation device with power supplied by the radio frequency energy harvesting module at block 307.

Thus, embodiments of the WIRELESS AND BATTERY-LESS MONITORING UNIT are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present invention is limited only by the claims that follow.

What is claimed is:

1. A wireless and battery-less sensor device, comprising:
a mechanical energy harvesting module;
a sensor electrically coupled to the mechanical energy harvesting module and configured to sense with power supplied by the mechanical energy harvesting module;
nonvolatile memory configured to store output from the sensor;
a radio frequency energy harvesting module; and
a radio frequency transmitter electrically coupled to the radio frequency energy harvesting module, the radio frequency transmitter configured to transmit the output from the sensor with power supplied by the radio frequency energy harvesting module.

2. A wireless and battery-less sensor device according to claim 1, wherein the mechanical energy harvesting module generates electrical power of 500 or less microwatts.

3. A wireless and battery-less sensor device according to claim 1, wherein the radio frequency energy harvesting module generates electrical power of at least 1 milliwatt.

4. A wireless and battery-less sensor device according to claim 1, wherein the mechanical energy harvesting module is a vibration-driven micropower generator.

5. A wireless and battery-less sensor device according to claim 1, wherein the sensor is a micro-electro-mechanical system.

6. A wireless and battery-less sensor device according to claim 1, wherein the mechanical energy harvesting module provides power to the sensor to and store the output to the nonvolatile memory, and the radio frequency energy harvesting module provides power to the radio frequency transmitter to transmit the stored output to a remote radio frequency interrogation device.

7. A wireless and battery-less sensor device according to claim 1, wherein the output from the sensor is a digital signal.

8. A system to monitor a body, comprising:
a body to be monitored;
a remote radio frequency interrogation device; and
at least one wireless and battery-less sensor device disposed to monitor the body and transmit sensed output to the remote radio frequency interrogation device, the sensor device comprising:
a mechanical energy harvesting module providing electrical power to a sensor, the sensor providing an output;
nonvolatile memory configured to store the output; and
a radio frequency energy harvesting module providing electrical power to a radio frequency transmitter for transmission of the output stored in the nonvolatile memory to the remote radio frequency interrogation device.

9. A system according to claim 8, wherein the output is a digital signal.

10. A system according to claim 8, wherein the remote radio frequency interrogation device provides radio frequency energy to the radio frequency energy harvesting module.

11. A system according to claim 8, wherein the remote radio frequency interrogation device detects the transmission of the output stored in the nonvolatile memory with backscatter data modulation.

12. A system according to claim 8, wherein the mechanical energy harvesting module generates electrical power of 500 or less microwatts and the radio frequency energy harvesting module generates electrical power of at least 1 milliwatt.

13. A system according to claim 8, wherein the mechanical energy harvesting module and the sensor are micro-electro-mechanical systems.

14. A system according to claim 8, wherein the body comprises a fixed structure.

15. A method of monitoring a body, comprising:
positioning at least one wireless and battery-less sensor device to monitor a body, the wireless and battery-less sensor device comprises:
a mechanical energy harvesting module;
a sensor;
nonvolatile memory;
a radio frequency energy harvesting module; and
a radio frequency transmitter;
generating electrical power with the mechanical energy harvesting module;
sensing a load on the sensor with power supplied by the mechanical energy harvesting module;
storing the load as output data in the nonvolatile memory;
detecting radio frequency energy with the wireless and battery-less sensor device;
generating electrical power with the radio frequency energy from the radio frequency energy harvesting module; and
transmitting the stored output data from the nonvolatile memory to a remote radio frequency interrogation device with power supplied by the radio frequency energy harvesting module.

16. A method according to claim 15, wherein the generating electrical power with the mechanical energy harvesting module step comprises generating 500 or less microwatts of electrical power with the mechanical energy harvesting module.

17. A method according to claim 15, wherein the generating electrical power with the radio frequency energy from the radio frequency energy harvesting module step comprises generating at least one milliwatt of electrical power with the radio frequency energy from the radio frequency energy harvesting module.

18. A method according to claim 15, further comprising generating the radio frequency energy with the remote radio frequency interrogation device.

19. A method according to claim 15, further comprising detecting the transmission of the output stored in the nonvolatile memory with the remote radio frequency interrogation device by backscatter data modulation.

20. A method according to claim 15, wherein the generating electrical power with the mechanical energy harvesting module step comprises generating 500 or less microwatts of electrical power with a vibration-driven micropower generator.
